(19) United States
(12) Patent Application Publication
(10) Pub. No.: US 2026/0111749 A1
(43) Pub. Date: Apr. 23, 2026

(54) LARGE LANGUAGE MODEL TRAINING METHOD, INFORMATION INTERACTION METHOD, DEVICE AND STORAGE MEDIUM

(71) Applicant: BEIJING BAIDU NETCOM SCIENCE TECHNOLOGY CO., LTD., Beijing (CN)

(72) Inventor: Linghui Meng, Beijing (CN)

(73) Assignee: BEIJING BAIDU NETCOM SCIENCE TECHNOLOGY CO., LTD., Beijing (CN)

(21) Appl. No.: 19/425,803

(22) Filed: Dec. 18, 2025

(30) Foreign Application Priority Data
Jun. 18, 2025 (CN) 202510820375.0

(51) Int. Cl. G06N 3/092; G06N 3/0475

(52) U.S. Cl. CPC G06N 3/092; G06N 3/0475

(57) ABSTRACT

A method for training a large language model includes: determining a second operation procedure of a first sample text through a first large language model; obtaining a second webpage address obtained through an interaction between the first large language model and a sample browser based on the second operation procedure; determining a target reward value obtained through the interaction between the first large language model and the sample browser according to the second webpage address and a first webpage address corresponding to the first sample text; and performing a reinforcement learning training on the first large language model according to the target reward value.

### CROSS-REFERENCE TO RELATED APPLICATIONS

The present application is based on and claims the priority of Chinese patent application No. 2025108203750 filed on Jun. 18, 2025, the entire content of which is incorporated herein by reference.

### TECHNICAL FIELD

The disclosure relates to the field of artificial intelligence technologies, such as large language model, agent, deep learning, human-machine interaction, etc., in particular to a method for training a large language model, an information interaction method, a device and a storage medium.

### BACKGROUND

With the continuous evolution of artificial intelligence technologies, large language model shows great potential in various application scenarios, especially under a webpage navigation task. After obtaining a target text inputted by a user under the webpage navigation task, how to train the large language model to interact with a browser based on its output to efficiently obtain a webpage address corresponding to a query target on a target website related to the target text has become an issue to improve an efficiency of human-machine interaction.

### SUMMARY

According to a first aspect of the disclosure, a method for training a large language model is provided. The method includes: obtaining a first sample text under a webpage navigation task, a first operation procedure corresponding to the first sample text and a first webpage address obtained based on the first operation procedure, in which the first operation procedure is used for obtaining a webpage address of a first query target on a first target website related to the first sample text, and the first query target is determined based on the first sample text; determining a second operation procedure of the first sample text based on the first sample text and a first large language model, in which the second operation procedure is used for obtaining a webpage address of a second query target on a second target website related to the first sample text, and the second query target is determined based on the first sample text; obtaining a second webpage address obtained through an interaction between the first large language model and a sample browser based on the second operation procedure; determining a target reward value for the interaction between the first large language model and the sample browser based on the first webpage address and the second webpage address; and obtaining a second large language model by performing a reinforcement learning training on the first large language model based on the target reward value.

According to a second aspect of the disclosure, an electronic device is provided. The electronic device includes: at least one processor, and a memory communicatively connected to the at least one processor. The memory stores instructions executable by the at least one processor, and the at least one processor may implement the method for training the large language model by executing the instructions.

According to a third aspect of the disclosure, a non-transitory computer-readable storage medium having computer instructions stored thereon is provided. The computer instructions are used to cause a computer to implement the method for training the large language model.

### BRIEF DESCRIPTION OF THE DRAWINGS

The accompanying drawings are used to better understand the solution and do not constitute a limitation to the disclosure.

FIG. 1 is a schematic diagram according to a first embodiment of the disclosure.

FIG. 2 is a schematic diagram according to a second embodiment of the disclosure.

FIG. 3 is a schematic diagram according to a third embodiment of the disclosure.

FIG. 4 is a schematic diagram according to a fourth embodiment of the disclosure.

FIG. 5 is a schematic diagram according to a fifth embodiment of the disclosure.

FIG. 6 is a schematic diagram according to a sixth embodiment of the disclosure.

FIG. 7 is a schematic diagram of an agent according to an embodiment of the disclosure.

FIG. 8 is a block diagram of an electronic device according to an embodiment of the disclosure.

### DETAILED DESCRIPTION

The following description of embodiments of the disclosure is provided in combination with the accompanying drawings, which includes various details of the embodiments of the disclosure to aid in understanding, and should be considered merely illustrative. Those skilled in the art understood that various changes and modifications of the embodiments described herein may be made without departing from the scope and spirit of the disclosure. For the sake of clarity and brevity, descriptions of well-known functions and structures are omitted from the following description.

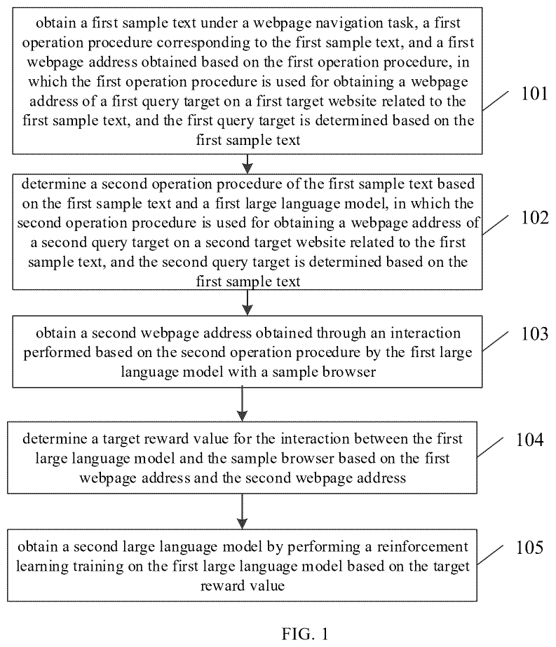

FIG. 1 is a schematic diagram according to a first embodiment of the disclosure. It should be noted that a method for training a large language model in embodiments of the disclosure is performed by an apparatus for training a large language model. The apparatus may be an electronic device or may be provided in the electronic device to enable a function for training the large language model.

The electronic device may be any device with a computing capability, such as a personal computer (PC), a mobile terminal, a server, etc. The mobile terminal may be, for example, a vehicle-mounted device, a mobile phone, a tablet computer, a personal digital assistant, a wearable device, a smart speaker, a server, a server cluster and other hardware devices with various operating systems, touch screens and/or displays.

It should be noted that the following embodiments are explained by taking the electronic device as the apparatus for training the large language model as an example.

As illustrated in FIG. 1, the method for training the large language model includes the following.

In block 101, a first sample text under a webpage navigation task, a first operation procedure corresponding to the first sample text, and a first webpage address obtained based on the first operation procedure are obtained, in which the first operation procedure is used for obtaining a webpage address of a first query target on a first target website related to the first sample text, and the first query target is determined based on the first sample text.

The first query target is a query target on a first website determined based on the first sample text.

The first operation procedure is determined based on the first sample text.

For example, the first sample text may be “searching for the latest TV show on Website 1”. Then, the first target website related to the first sample text is “Website 1”, and the first query target on the first target website is determined as “the latest TV show” based on the first sample text.

In some embodiments, in order to reduce the cost of acquiring the first sample text, the first sample text may be obtained by: obtaining a text template under the webpage navigation task and a prompt word template corresponding to the text template, in which the text template includes a position to be filled, and the prompt word template includes a plurality of candidate contents that is able to be filled in the position to be filled; selecting a target content from the plurality of candidate contents, and obtaining the first sample text by filling the target content in the position to be filled in the text template. Therefore, generating the first sample text based on the text template may avoid the tedious manual writing of the first sample text, which greatly reduce the cost of obtaining the first sample text.

The position to be filled is preset according to actual needs. If the text template is for example “searching for the latest TV show on {the position to be filled}”, then the plurality of candidate contents corresponding to the position to be filled may include: “Website 1,” “Website 2,” “Website 3,” etc.

If the text template is for example “searching for the latest {the position to be filled} on Website 1”, assuming that Website 1 is a website that provides video resources, then the plurality of candidate contents corresponding to the position to be filled may include, but are not limited to, “TV series,” “movie,” “TV show,” etc.

If the text template is for example “searching for {the position to be filled} on Website 2”, assuming that Website 2 is a website that sales various goods, then the plurality of candidate contents corresponding to the position to be filled may include, but are not limited to, “Product 1,” “Product 2,” “Product 3,” “Product 4,” etc.

It is understood that there may be one or more positions to be filled in the text template, and the number of positions to be filled is not limited in the disclosure.

For example, there may be two positions to be filled, which may be a position 1 to be filled and a position 2 to be filled, and the text template may be “searching for the latest {the position 2 to be filled} on {the position 1 to be filled}”. In this case, the candidate contents corresponding to the position 1 to be filled may include “Website 1,” “Website 2,” “Website 3” and “Website 4” for providing video resources, and the candidate contents corresponding to the position 2 to be filled may include, but are not limited to, “TV series,” “movie,” “TV show,” etc.

In some embodiments, in order to accurately and quickly obtain the first sample text, selecting the target content from the plurality of candidate contents, and obtaining the first sample text by filling the target content in the position to be filled in the text template includes: generating a first prompt word based on the text template and the prompt word template, in which the first prompt word is used for instructing a sample generating large model to select a target content from the plurality of candidate contents and obtain the first sample text by filling the target content in the position to be filled in the text template; inputting the first prompt word into the sample generating large model, and obtaining the first sample text outputted by the sample generating large model. Therefore, the sample generating large model is prompted using the first prompt word, such that the sample generating large model may accurately learn a background and a target of generating the content and accurately generate the first sample text, which reduce the cost of obtaining the first sample text.

It is understood that there may be a plurality of first sample texts in the disclosure.

It should be noted that the sample generating large model may generate a plurality of different first sample texts. For example, the sample generating large model may generate a plurality of different first sample texts all at once or sequentially (i.e., generate a single first sample text at a time, and perform the generation processing of the first sample text for multiple times).

In other embodiments, in order to reduce the cost of obtaining the first operation procedure, a second prompt word may be generated based on the first sample text. The second prompt word is used for instructing to analyze the first sample text to determine a chain of thought of the first sample text, and determine a corresponding operation procedure based on the chain of thought. The second prompt may be inputted into a target large model, and the first operation procedure is determined according to an operation procedure outputted by the target large model.

As an example, the operation procedure outputted by the target large model may be directly taken as the first operation procedure. As another example, the operation procedure outputted by the target large model may be manually processed, and the manually processed operation procedure is taken as the first operation procedure.

The target large model refers to an existing general large model.

In block 102, a second operation procedure of the first sample text is determined according to the first sample text and a first large language model, in which the second operation procedure is used for obtaining a webpage address of a second query target on a second target website related to the first sample text, and the second query target is determined based on the first sample text.

In some embodiments, the first sample text may be inputted into the first large language model, and the first large language model analyzes the first sample text, performs a logical reasoning processing on the process of obtaining the second query target from the second target website related to the first sample text to obtain a chain of thought used for obtaining the second query target on the second target website, determines the second operation procedure used for obtaining the second query target on the second target website based on the chain of thought, and outputs the second operation procedure.

In block 103, a second webpage address obtained through an interaction performed based on the second operation procedure by the first large language model with a sample browser is obtained.

The sample browser may be any browser in the electronic device, which is not limited in the disclosure.

It is understood that the second operation procedure includes a plurality of operation steps that are executed sequentially. The plurality of operation steps may be executed sequentially according to an execution order, so that the first large language model may interact with the sample browser based on an operation step that is being executed. Correspondingly, for a first operation step that is being executed, the first large language model determines operation instructions to be executed by the sample browser according to the first operation step, and the sample browser is invoked to execute the operation instructions and return an operation result. For an i^{th} operation step that is being executed, the first large language model obtains an operation result obtained through an interaction performed based on the i^{th} operation step by the first large language mode with the sample browser, determines operation instructions to be executed by the sample browser based on the i^{th} operation step, invokes the sample browser to execute the corresponding operation instructions, and then receives an operation result returned by the sample browser based on the operation instructions, where i is an integer greater than or equal to 1 and less than N, and N represents the number of operation steps included in the second operation procedure.

The “operation result” in the disclosure may include a webpage source code of a webpage obtained by the sample browser based on the operation instructions.

In block 104, a target reward value is determined for the interaction between the first large language model and the sample browser based on the first webpage address and the second webpage address.

In some embodiments, a matching result is obtained by matching the first webpage address and the second webpage address, and the target reward value is determined for the interaction between the first large language model and the sample browser according to the matching result.

The matching result is used for indicating whether the first webpage address matches the second webpage address.

It is understood that in a case where the first webpage address is consistent with the second webpage address, it means that the first webpage address matches the second webpage address. In a case where the first webpage address is different from the second webpage address, it means that the first webpage address does not match the second webpage address.

In some embodiments, in a case that there are a plurality of second operation procedures determined based on the first large language model, determining the target reward value for the interaction between the first large language model and the sample browser according to the first webpage address and the second webpage address includes: obtaining respective matching results by matching second webpage addresses corresponding to the second operation procedures with the first webpage address respectively; and determining the target reward value for the interaction between the first large language model and the sample browser according to the respective matching results.

In some embodiments, the first number of webpage addresses matching the first webpage address may be obtained among the plurality of second webpage addresses according to the respective matching results, and the target reward value is determined for the interaction between the first large language model and the sample browser according to the first number.

In other embodiments, the first number of webpage addresses matching the first webpage address and the second number of webpage addresses that do not match the first webpage address are obtained among the plurality of second webpage addresses according to the respective matching results, and the target reward value is determined for the interaction between the first large language model and the sample browser according to the first number and the second number.

In other embodiments, obtaining the respective matching results by matching the second webpage addresses corresponding to the second operation procedures with the first webpage address respectively and determining the target reward value for the interaction between the first large language model and the sample browser according to the respective matching results include: for each second operation procedure, matching the second webpage address obtained based on the second operation procedure with the first webpage address to obtain a respective matching result; determining a target score corresponding to the first operation procedure according to the respective matching result between the first webpage address and the second webpage address; determining an average score and a score standard deviation according to the target score corresponding to each first operation procedure; obtaining a standardized score corresponding to each first operation procedure by performing a standardizing processing on the target score corresponding to each first operation procedure according to the average score and the score standard deviation; and obtaining the target reward value for the interaction between the first large language model and the sample browser by performing an averaging processing on the standardized score corresponding to each first operation procedure.

In the embodiments, the target reward value is determined for the interaction between the first large language model and the sample browser in combination with the respective matching results of the second webpage addresses corresponding to the plurality of second operation procedures with the first webpage address, and the reinforcement learning is performed on the first large language model in combination with the determined target reward value, which improves the generalization and stability of a second large language model and avoids local optimization and over-fitting, so that the second large language model may generate more diverse outputs with higher quality.

In block 105, the second large language model is obtained by performing a reinforcement learning training on the first large language model according to the target reward value.

In some embodiments, parameters of the first large language model are optimized and adjusted based on the target reward value, and then the adjusted model is iteratively trained until a preset ending condition is met, to obtain the second large language model with optimized performance.

The preset ending condition refers to a preset condition for ending the training process of the first large language model. For example, the preset ending condition may be that the number of training processes reaches a preset number, the target reward value is greater than a preset value, or a change in the target reward value tends to be stable, that is, a difference between target reward values corresponding to two or more adjacent training processes is less than a preset value, which means that there is basically no change in the target reward value.

In the method for training the large language model according to embodiments of the disclosure, the second operation procedure of the first sample text is determined according to the first large language model. The second webpage address obtained through the interaction performed based on the second operation procedure by the first large language model with the sample browser is obtained. By matching the second webpage address with the first webpage address obtained by the first operation procedure based on the first sample text, the matching result is obtained. According to the matching result, the target reward value is determined for the interaction between the first large language model and the sample browser, and the second large language model is obtained by performing the reinforcement learning training on the first large language model according to the target reward value. The obtained second large language model may analyze a text under the webpage navigation task and accurately determine an operation procedure for obtaining a query target on a target website related to the corresponding text, so as to accurately obtain a webpage address of the query target meeting the user's needs based on the operation procedure.

In some embodiments, to improve the efficiency of obtaining the second large language model, the first large language model in the embodiment is a trained large language model.

It is understandable that as a trained large language model, the first large language model may provide a good initial state for obtaining effective strategies more quickly in the subsequent reinforcement learning stage, which improves the efficiency of obtaining the second large language model.

It is understandable that in different application scenarios, the first large language model is obtained in different ways.

For example, one implementation of obtaining the first large language model includes: inputting the first sample text into an initial large language model to obtain a predicted operation procedure of the first sample text outputted by the initial large language model, and obtaining the first large language model by performing a supervised fine-tuning training on the initial large language model according to the predicted operation procedure and the first operation procedure. The predicted operation procedure is used for obtaining a webpage address of a query target on a website related to the first sample text, and the query target is obtained by analyzing an intention of the first sample text via the initial large language model.

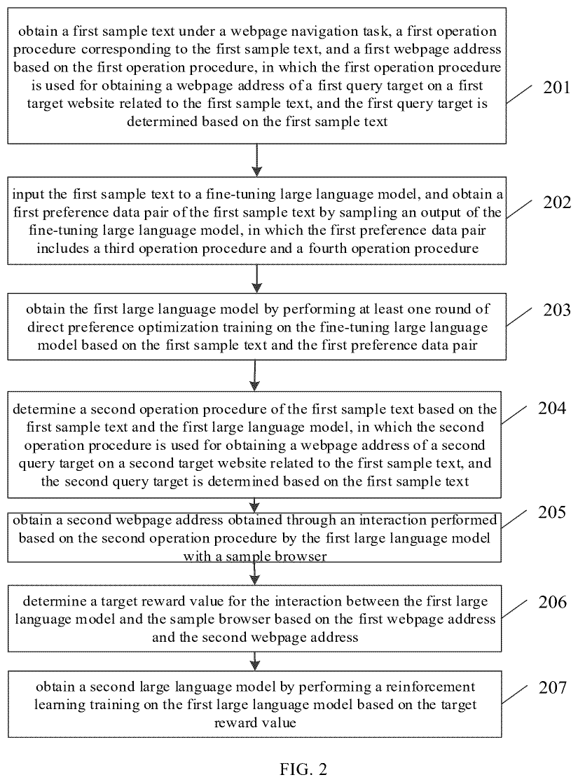

Another implementation of obtaining the first large language model is described below as an example in combination with FIG. 2.

FIG. 2 is a schematic diagram according to a second embodiment of the disclosure.

As illustrated in FIG. 2, the method includes the following.

In block 201, a first sample text under a webpage navigation task, a first operation procedure corresponding to the first sample text, and a first webpage address obtained based on the first operation procedure are obtained, in which the first operation procedure is used for obtaining a webpage address of a first query target on a first target website related to the first sample text, and the first query target is determined based on the first sample text.

It should be noted that for the description of block 201, reference may be made to the related descriptions in other embodiments, which will not be repeated here.

In block 202, the first sample text is inputted to a fine-tuning large language model, and a first preference data pair of the first sample text is obtained by sampling an output of the fine-tuning large language model, in which the first preference data pair includes a third operation procedure and a fourth operation procedure.

The third operation procedure is an operation procedure with the highest upper confidence bound (UCB) score among operation procedures outputted by the fine-tuning large language model, and the fourth operation procedure is an operation procedure with the lowest UCB score among the operation procedures outputted by the fine-tuning large language model.

The third operation procedure and the fourth operation procedure are both used to obtain a webpage address of a third query target on a third target website related to the first sample text, and the third query target is determined according to the first sample text.

It is understood that the third query target is determined by the fine-tuning large language model according to the first sample text.

In some embodiments, the UCB score of the third operation procedure is determined according to a matching result of a third webpage address obtained through the third operation procedure and the first webpage address, and according to a probability of outputting the third operation procedure by the fine-tuning large language model. The UCB score of the fourth operation procedure is determined according to a matching result of a fourth webpage address obtained through the fourth operation procedure and the first webpage address, and according to a probability of outputting the fourth operation procedure by the fine-tuning large language model. Therefore, a UCB score of an operation procedure may be accurately determined in combination with the matching result between the webpage address obtained by the corresponding operation procedure and the first webpage address, as well as the probability of outputting the corresponding operation procedure by the first preference optimization large language model.

In some embodiments, in a case where it is determined that the third webpage address matches the first webpage address based on the matching result between the third webpage address and the first webpage address, the corresponding score is a first score. In a case where it is determined that the third webpage address does not match the first webpage address based on the matching result between the third webpage address and the first webpage address, the corresponding score is a second score.

The first score and the second score are preset according to actual needs. For example, the first score may be 0, and the second score may be 1.

In some embodiments, in a case where it is determined that the fourth webpage address matches the first webpage address based on the matching result between the fourth webpage address and the first webpage address, the corresponding score is a first score. In a case where it is determined that the fourth webpage address does not match the first webpage address based on the matching result between the fourth webpage address and the first webpage address, the corresponding score is a second score.

The first score and the second score are preset according to actual needs. For example, the first score may be 0, and the second score may be 1.

In other embodiments, the UCB score of the third operation procedure is determined according to the probability of outputting the third operation procedure by the fine-tuning large language model. The UCB score of the fourth operation procedure is determined according to the probability of outputting the fourth operation procedure by the fine-tuning large language model.

In some embodiments, in the process of sampling the plurality of operation procedures outputted by the fine-tuning large language model, the respective probability that the fine-tuning large language model outputs each of the above operation procedures is determined based on the Monte-Carlo Tree Search (MCTS) algorithm. Based on the respective probability of each operation procedure and the UCB algorithm, the respective UCB score corresponding to each operation procedure is determined. The operation procedure with the highest UCB score among the operation procedures is taken as the third operation procedure, and the operation procedure with the lowest UCB score among the plurality of operation procedures is taken as the fourth operation procedure.

In some embodiments, the fine-tuning large language model is obtained by performing a supervised fine-tuning processing on an initial large language model based on the first sample text and the corresponding first operation procedure.

In some embodiments, obtaining the fine-tuning large language model by performing the supervised fine-tuning processing on the initial large language model based on the first sample text and the corresponding first operation procedure includes: obtaining an eighth operation procedure by inputting the first sample text into the initial large language model, in which the eighth operation procedure is used for obtaining a webpage address of a sixth query target on a sixth target website related to the first sample text, and the sixth query target is determined according to the first sample text; and obtaining the fine-tuning large language model by performing a supervised fine-tuning training on the initial large language model according to the eighth operation procedure and the first operation procedure. In this way, the fine-tuning large language model may be obtained based on the first sample text and the first operation procedure, which may provide a high-quality initial state for improving the efficiency of preference learning in the future, thereby improving the efficiency of obtaining a first large language model.

It is understood that the sixth query target is determined by the initial large language model according to the first sample text.

In some embodiments, to improve a logical reasoning capability of the obtained fine-tuning large language model, and further improve a logical reasoning capability of a second large language model obtained based on the fine-tuning large language model, an initial chain of thought on which the first operation procedure corresponding to the first sample text is based is improved based on the advanced large model to obtain an improved chain of thought, and an improved first operation procedure is obtained based on the improved chain of thought. It should be noted that the logical reasoning capability of the advanced large model is higher than that of the target large model that is used to determine the initial chain of thought on which the first operation procedure is based.

Correspondingly, based on the first sample text and the improved first operation procedure, the supervised fine-tuning training is performed on the initial large language model to obtain the fine-tuning large language model, which improves the logical reasoning capability of the obtained fine-tuning large language model.

In block 203, the first large language model is obtained by performing at least one round of direct preference optimization training on the fine-tuning large language model according to the first sample text and the first preference data pair.

In some embodiments, to further improve the stability of the obtained first large language model, a second sample text under the webpage navigation task may be obtained. A difficulty level of the second sample text is greater than that of the first sample text. The first preference optimization large language model is obtained by performing at least one round of direct preference optimization training on the fine-tuning large language model according to the first sample text and the first preference data pair. The second sample text is inputted into the first preference optimization large language model and an output of the first preference optimization large language model is sampled to obtain a second preference data pair of the second sample text. The second preference data pair includes a fifth operation procedure and a sixth operation procedure. The fifth operation procedure is an operation procedure with the highest UCB score among operation procedures outputted by the first preference optimization large language model, and the sixth operation procedure is an operation procedure with the lowest UCB score among the operation procedures outputted by the first preference optimization large language model. The fifth operation procedure and the sixth operation procedure are both used to obtain a webpage address of a fourth query target on a fourth target website related to the second sample text, and the fourth query target is determined according to the second sample text. The first large language model is obtained by performing at least one round of direct preference optimization on the first preference optimization large language model according to the second sample text and the second preference data pair. Therefore, after performing the at least one round of direct preference optimization on the fine-tuning large language model, it continues to perform at least one round of direct preference optimization on the large language model processed with the preference optimization in combination with the second sample text whose difficulty level is greater than that of the first sample text, which improves the stability of the obtained first large language model.

In some embodiments, the difficulty level of the second sample text is determined based on the number of operation steps included in a seventh operation procedure corresponding to the second sample text, and the difficulty level of the first sample text is determined based on the number of operation steps included in the first operation procedure.

In other embodiments, in a case that both the first sample text and the second sample text are obtained based on the text template, the difficulty level of the first sample text is determined based on the number of positions to be filled in a text template based on which the first sample text is generated, and the difficulty level of the second sample text is determined based on the number of positions to be filled in a text template based on which the second sample text is generated.

In other embodiments, the difficulty level of the first sample text is determined based on the number of operation steps included in the first operation procedure and the number of positions to be filled in the text template based on which the first sample text is generated, and the difficulty level of the second sample text is determined based on the number of operation steps included in the seventh operation procedure and the number of positions to be filled in the text template based on which the second sample text is generated.

In some embodiments, a fifth webpage address is obtained through the seventh operation procedure corresponding to the second sample text, in which the seventh operation procedure is used for obtaining a webpage address of a fifth query target on a fifth target website related to the second sample text, and the fifth query target is determined according to the second sample text. The UCB score of the fifth operation procedure is determined according to a matching result between a sixth webpage address obtained through the fifth operation procedure and the fifth webpage address and based on a probability that the first preference optimization large language model outputs the fifth operation procedure, and the UCB score of the sixth operation procedure is determined according to a matching result between a seventh webpage address obtained through the sixth operation procedure and the fifth webpage address and based on a probability that the first preference optimization large language model outputs the sixth operation procedure. In this way, a UCB score corresponding to an operation procedure may be accurately determined in combination with the matching result between a webpage address obtained corresponding to the operation procedure and the fifth webpage address and a probability that the first preference optimization large language model outputs the corresponding operation procedure.

In some embodiments, in a case that it is determined that the sixth webpage address matches the fifth webpage address based on the matching result of the sixth webpage address and the fifth webpage address, the corresponding score is a first score. In a case that it is determined that the sixth webpage address does match the fifth webpage address based on the matching result of the sixth webpage address and the fifth webpage address, the corresponding score is a second score.

The first score and the second score may be preset according to actual needs. For example, the first score may be 0, and the second score may be 1.

In some embodiments, in a case that it is determined that the seventh webpage address matches the fifth webpage address based on the matching result of the seventh webpage address and the fifth webpage address, the corresponding score is a first score. In a case that it is determined that the seventh webpage address does match the fifth webpage address based on the matching result of the seventh webpage address and the fifth webpage address, the corresponding score is a second score.

The first score and the second score may be preset according to actual needs. For example, the first score may be 0, and the second score may be 1.

In block 204, a second operation procedure of the first sample text is determined according to the first sample text and the first large language model, in which the second operation procedure is used for obtaining a webpage address of a second query target on a second target website related to the first sample text, and the second query target is determined based on the first sample text.

In block 205, a second webpage address obtained through an interaction performed based on the second operation procedure by the first large language model with a sample browser is obtained.

In block 206, a target reward value for the interaction between the first large language model and the sample browser is determined according to the first webpage address and the second webpage address.

In block 207, a second large language model is obtained by performing a reinforcement learning training on the first large language model according to the target reward value.

It should be noted that for the detailed description of blocks 204-207, reference may be made to the related descriptions in other embodiments, which will not be repeated here.

In the embodiment, the first preference data pair is automatically constructed in combination with the first sample text and the fine-tuning large language model. The first large language model is obtained by performing the direct preference optimization training on the fine-tuning large language model according to the constructed first preference data pair and the first sample text, which may provide a more stable and reasonable initial state for obtaining effective strategies more quickly in the reinforcement learning stage, which improves the efficiency of obtaining the second large language model.

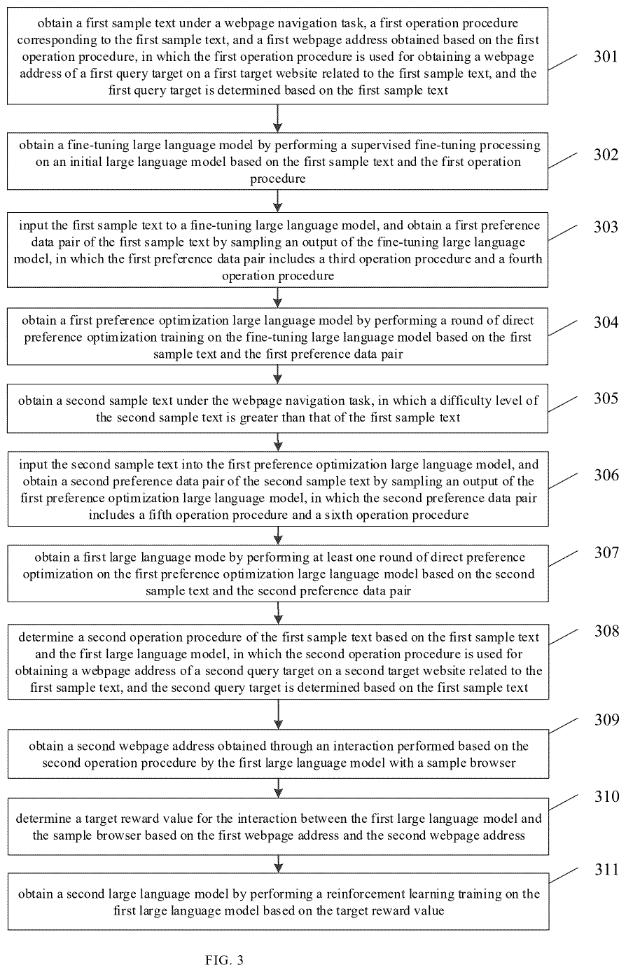

In order to clearly understand the disclosure, the method for training the large language model of the embodiments will be explained by examples in combination with FIG. 3.

FIG. 3 is a schematic diagram according to a third embodiment of the disclosure.

As illustrated in FIG. 3, the method includes the following.

In block 301, a first sample text under a webpage navigation task, a first operation procedure corresponding to the first sample text, and a first webpage address obtained based on the first operation procedure are obtained, in which the first operation procedure is used for obtaining a webpage address of a first query target on a first target website related to the first sample text, and the first query target is determined based on the first sample text.

In some embodiments, a text template under the webpage navigation task and a prompt word template corresponding to the text template are obtained. The text template includes a position to be filled, and the prompt word template includes a plurality of candidate contents to be filled in the position to be filled. A first prompt word is generated according to the text template and the prompt word template. The first prompt word is used for instructing a sample generating large model to select a target content from the plurality of candidate contents and obtain the first sample text by filling the target content in the position to be filled in the text template. The first prompt word is inputted into the sample generating large model, and the first sample text outputted by the sample generating large model is obtained.

In some embodiments, a second prompt word is generated according to the first sample text. The second prompt word is used for instructing to analyze the first sample text to determine a chain of thought of the first sample text, and determine a corresponding operation procedure based on the chain of thought. The second prompt word is inputted into a target large model, and the first operation procedure is determined according to an operation procedure outputted by the target large model.

The operation procedure outputted by the target large model may be directly taken as the first operation procedure. Or the operation procedure outputted by the target large model may be manually processed, and the manually processed operation procedure is taken as the first operation procedure.

The target large model is an existing general large model.

The above text template may be obtained by analyzing historical input texts under the webpage navigation task, or obtained by other means, which is not limited by the embodiments.

In other embodiments, the first sample text may be expanded through a general large language model.

In other embodiments, a ninth operation procedure of the expanded first sample text is determined by the target large model, and a first target webpage address obtained based on the ninth operation procedure is obtained. The ninth operation procedure is used to obtain a webpage address of an eighth query target on an eighth target website related to the expanded first sample text, and the eighth query target is obtained according to the expanded first sample text.

In block 302, a fine-tuning large language model is obtained by performing a supervised fine-tuning processing on an initial large language model according to the first sample text and the first operation procedure.

For the detailed description of block 302, reference may be made to the related descriptions in other embodiments, which will not be repeated here.

In block 303, the first sample text is inputted to a fine-tuning large language model, and a first preference data pair of the first sample text is obtained by sampling an output of the fine-tuning large language model, in which the first preference data pair includes a third operation procedure and a fourth operation procedure.

The third operation procedure is an operation procedure with the highest UCB score among operation procedures outputted by the fine-tuning large language model, and the fourth operation procedure is an operation procedure with the lowest UCB score among the operation procedures outputted by the fine-tuning large language model. The third operation procedure and the fourth operation procedure are both used to obtain a webpage address of a third query target on a third target website related to the first sample text, and the third query target is determined according to the first sample text.

It is understood that the third query target is determined by the fine-tuning large language model according to the first sample text.

The UCB score of the third operation procedure is determined according to a matching result between a third webpage address obtained through the third operation procedure and the first webpage address and according to a probability that the fine-tuning large language model outputs the third operation procedure, and the UCB score of the fourth operation procedure is determined according to a matching result between a fourth webpage address obtained through the fourth operation procedure and the first webpage address and according to a probability that the fine-tuning large language model outputs the fourth operation procedure.

In block 304, a first preference optimization large language model is obtained by performing a round of direct preference optimization training on the fine-tuning large language model according to the first sample text and the first preference data pair.

In block 305, a second sample text under the webpage navigation task is obtained, in which a difficulty level of the second sample text is greater than that of the first sample text.

For the method of obtaining the difficulty levels of the first sample text and of the second sample text, reference may be made to the relevant descriptions in other embodiments, which will not be repeated here.

In block 306, the second sample text is inputted into the first preference optimization large language model, and a second preference data pair of the second sample text is obtained by sampling an output of the first preference optimization large language model, in which the second preference data pair includes a fifth operation procedure and a sixth operation procedure.

The fifth operation procedure is an operation procedure with the highest UCB score among operation procedures outputted by the first preference optimization large language model.

The sixth operation procedure is an operation procedure with the lowest UCB score among the operation procedures outputted by the first preference optimization large language model.

The fifth operation procedure and the sixth operation procedure are both used to obtain a webpage address of a fourth query target on a fourth target website related to the second sample text.

The fourth query target is determined according to the second sample text.

It is understood that the fourth query target is determined by the first preference optimization large language model according to the second sample text.

The UCB score of the fifth operation procedure is determined according to a matching result between a sixth webpage address obtained through the fifth operation procedure and the fifth webpage address and according to a probability that the first preference optimization large language model outputs the fifth operation procedure, and the UCB score of the sixth operation procedure is determined according to a matching result between a seventh webpage address obtained through the sixth operation procedure and the fifth webpage address and according to a probability that the first preference optimization large language model outputs the sixth operation procedure.

In some embodiments, a fifth webpage address may be obtained through a seventh operation procedure corresponding to the second sample text. The seventh operation procedure is used for obtaining a webpage address of a fifth query target on a fifth target website related to the second sample text, and the fifth query target is determined according to the second sample text.

The UCB score of the fifth operation procedure is determined according to a matching result of a sixth webpage address obtained through the fifth operation procedure with the fifth webpage address and according to a probability that the first preference optimization large language model outputs the fifth operation procedure. The UCB score of the sixth operation procedure is determined according to a matching result of a seventh webpage address obtained through the sixth operation procedure with the fifth webpage address and according to a probability that the first preference optimization large language model outputs the sixth operation procedure.

In block 307, a first large language model is obtained by performing at least one round of direct preference optimization on the first preference optimization large language model according to the second sample text and the second preference data pair.

In block 308, a second operation procedure of the first sample text is determined according to the first sample text and the first large language model. The second operation procedure is used for obtaining a webpage address of a second query target on a second target website related to the first sample text, and the second query target is determined based on the first sample text.

In block 309, a second webpage address obtained through an interaction performed based on the second operation procedure by the first large language model with a sample browser is obtained.

In block 310, a target reward value is determined for the interaction between the first large language model and the sample browser according to the first webpage address and the second webpage address.

In block 311, a second large language model is obtained by performing a reinforcement learning training on the first large language model according to the target reward value.

In embodiments, the supervised fine-tuning training is performed on the initial large language model based on the first sample text and the first operation procedure corresponding to the first sample text to obtain the fine-tuning large language model. The fine-tuning large language model automatically generates the first preference data pair based on the first sample text. Then, one round of direct preference optimization training is performed on the fine-tuning large language model based on the first sample text and the first preference data pair to obtain the first preference optimization large language model. Moreover, the second sample text whose difficulty level is greater than that of the first sample text is obtained and input into the first preference optimization large language model to obtain the second preference data pair. According to the second sample text and the second preference data pair, the first preference optimization large language model is trained to obtain the first large language model, so that the stability of the output of the trained first language model may be improved. The second operation procedure of the first sample text is determined based on the first sample text and the first large language model. The target reward value is determined for the interaction between the first large language model and the sample browser based on the first webpage address and the second webpage address. Based on the target reward value, the reinforcement learning training is performed on the first large language model to obtain the second large language model. Thus, the reinforcement learning training is implemented efficiently on the first large language model in combination with the target reward value determined based on the first webpage address and the second webpage address, to obtain the second large language model with better generalization capability.

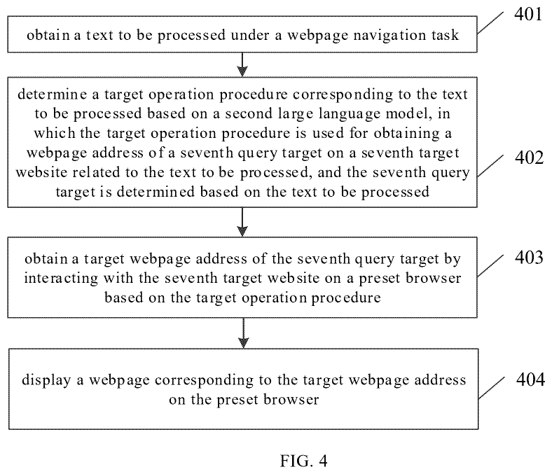

FIG. 4 is a schematic diagram of a fourth embodiment according to the disclosure. It should be noted that the information interaction method according to the embodiment of the disclosure is performed by an agent. Information interaction intelligence means a computer program depending on large language models, having a planning capability, a memory capability and a capability to use tool functions, and being capable of independently executing given tasks. The agent is configured in an electronic device to enable an information interaction function.

As illustrated in FIG. 4, the method includes the following.

In block 401, a text to be processed under a webpage navigation task is obtained.

In block 402, a target operation procedure corresponding to the text to be processed is determined according to a second large language model, in which the target operation procedure is used for obtaining a webpage address of a seventh query target on a seventh target website related to the text to be processed, and the seventh query target is determined based on the text to be processed.

The second large language model is a model that has been trained according to the method for training the large language model according to the disclosure.

In block 403, a target webpage address of the seventh query target is obtained by interacting with the seventh target website on a preset browser based on the target operation procedure.

It should be noted that the preset browser may be any browser in the electronic device that is able to communicate with the agent.

In some embodiments, the target operation procedure includes a plurality of operation steps that are executed sequentially. The plurality of operation steps are executed sequentially according to an execution order, so that the first large language model may interact with the sample browser based on an operation step that is being executed. Correspondingly, for a first operation step that is being executed, the first large language model determines operation instructions to be executed by the sample browser according to the first operation step, and the sample browser is invoked to execute the operation instructions to return an operation result. For an i^{th} operation step that is being executed, the first large language model obtains an operation result obtained through the interaction with the sample browser based on the i^{th} operation step, determines operation instructions to be executed by the sample browser and calls the sample browser to execute the corresponding operation instructions, and then receives an operation result returned by the sample browser based on the operation instructions, where i is an integer greater than or equal to 1 and less than N, and N represents the number of operation steps included in the target operation procedure.

For example, if the text to be processed is “searching for the latest TV show on Website 1”, the obtained target operation procedure includes three operation steps that are executed sequentially. The first operation step is: opening the Website 1, the second operation step is: searching for a label or a page relating to the latest TV show, and the third operation step is: analyzing a page content to obtain information on the latest TV show. Correspondingly, a first operation instruction for opening the Website 1 is sent to a preset browser based on the first operation step, and the first operation instruction includes a webpage address of Website 1. The preset browser opens the Website 1 based on webpage address information of Website 1 and returns webpage source codes of Website 1 to the agent. The agent determines a second operation instruction to be executed by the preset browser according to the webpage source codes of Website 1 and the second operation step. The preset browser executes the second operation instruction to obtain an operation result. Assuming that the second operation instruction is: entering “latest TV show” in a search box on Website 1 and then clicking a search key on Website 1, the operation result returned by the preset browser may be “webpage source codes of a search result page”. According to the operation result and the third operation step, the agent determines the third operation instruction that the preset browser needs to execute. The third operation instruction may be clicking a first search result on the search result page, and the preset browser is called to click the first search result on the search result page and provide the agent with webpage address information corresponding to the first search result. The webpage address information corresponding to the first search result is a webpage address of a query target on a third target website. Then, the agent may display the webpage address information.

In block 404, a webpage corresponding to the target webpage address is displayed on the preset browser.

With the information interaction method according to the embodiments of the disclosure, the text to be processed under the webpage navigation task is obtained, and the target operation procedure corresponding to the text to be processed is determined according to the second large language model. The target webpage address of the seventh query target is obtained by interacting with the seventh target website on the preset browser based on the target operation procedure, and the webpage corresponding to the target webpage address is displayed on the preset browser. Therefore, the webpage of the query target related to the text to be processed may be automatically displayed on the preset browser based on the text to be processed inputted by the user under the webpage navigation task.

In order to realize the above embodiments, the disclosure also provides an apparatus for training a large language model.

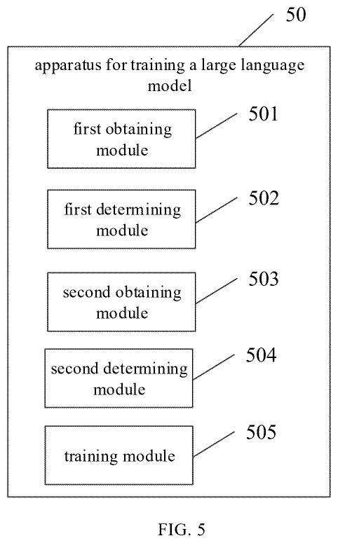

FIG. 5 is a schematic diagram according to a fifth embodiment of the disclosure.

As illustrated in FIG. 5, the apparatus 50 for training the large language model includes: a first obtaining module 501, a first determining module 502, a second obtaining module 503, a second determining module 504 and a training module 505.

The first obtaining module 501 is configured to obtain a first sample text under a webpage navigation task, a first operation procedure corresponding to the first sample text, and a first webpage address obtained based on the first operation procedure, in which the first operation procedure is used for obtaining a webpage address of a first query target on a first target website related to the first sample text, and the first query target is determined based on the first sample text.

The first determining module 502 is configured to determine a second operation procedure of the first sample text according to the first sample text and a first large language model, in which the second operation procedure is used for obtaining a webpage address of a second query target on a second target website related to the first sample text, and the second query target is determined based on the first sample text.

The second obtaining module 503 is configured to obtain a second webpage address obtained through an interaction performed based on the second operation procedure by the first large language model with a sample browser.

The second determining module 504 is configured to determine a target reward value for the interaction between the first large language model and the sample browser according to the first webpage address and the second webpage address.

The training module 505 is configured to obtain a second large language model by performing a reinforcement learning training on the first large language model according to the target reward value.

As a possible implementation of the embodiments of the disclosure, the first obtaining module 501 is configured to obtain a text template under the webpage navigation task and a prompt word template corresponding to the text template, in which the text template includes a position to be filled, and the prompt word template includes a plurality of candidate contents to be filled in the position to be filled; to select a target content from the plurality of candidate contents, and obtain the first sample text by filling the target content in the position to be filled in the text template.

Selecting the target content from the plurality of candidate contents, and obtaining the first sample text by filling the target content in the position to be filled in the text template includes: generating a first prompt word according to the text template and the prompt word template, in which the first prompt word is used for instructing a sample generating large model to select a target content from the plurality of candidate contents and obtain the first sample text by filling the target content in the position to be filled in the text template; inputting the first prompt word into the sample generating large model, and obtaining the first sample text outputted by the sample generating large model.

As a possible implementation of the embodiments of the disclosure, in a case that there are a plurality of second operation procedures, the second determining module 504 is configured to: obtain respective matching results by matching second webpage addresses corresponding to the second operation procedures with the first webpage address respectively; and determine the target reward value for the interaction between the first large language model and the sample browser according to the respective matching results.

As a possible implementation of the embodiment of the disclosure, the apparatus further includes: a first processing module. The first processing module is configured to: input the first sample text to a fine-tuning large language model, and obtain a first preference data pair of the first sample text by sampling an output of the fine-tuning large language model, in which the first preference data pair includes a third operation procedure and a fourth operation procedure; the third operation procedure is an operation procedure with the highest UCB score among operation procedures outputted by the fine-tuning large language model, and the fourth operation procedure is an operation procedure with the lowest UCB score among the operation procedures outputted by the fine-tuning large language model; the third operation procedure and the fourth operation procedure are both used to obtain a webpage address of a third query target on a third target website related to the first sample text; and the third query target is determined according to the first sample text; and obtain the first large language model by performing a direct preference optimization training on the fine-tuning large language model according to the first sample text and the first preference data pair.

As a possible implementation of the embodiments of the disclosure, the UCB score of the third operation procedure is determined according to a matching result of a third webpage address obtained through the third operation procedure with the first webpage address and according to a probability that the fine-tuning large language model outputs the third operation procedure, and the UCB score of the fourth operation procedure is determined according to a matching result of a fourth webpage address obtained through the fourth operation procedure with the first webpage address and according to a probability that the fine-tuning large language model outputs the fourth operation procedure.

As a possible implementation of the embodiment of the disclosure, the apparatus further includes a second processing module, configured to obtain a second sample text under the webpage navigation task, in which a difficulty level of the second sample text is greater than that of the first sample text.

The process for the first processing module to obtain the first large language model by performing the direct preference optimization training on the fine-tuning large language model according to the first sample text and the first preference data pair includes: obtaining a first preference optimization large language model by performing at least one round of direct preference optimization training on the fine-tuning large language model according to the first sample text and the first preference data pair; inputting the second sample text into the first preference optimization large language model, and obtaining a second preference data pair of the second sample text by sampling an output of the first preference optimization large language model, in which the second preference data pair includes a fifth operation procedure and a sixth operation procedure; the fifth operation procedure is an operation procedure with the highest UCB score among operation procedures outputted by the first preference optimization large language model, and the sixth operation procedure is an operation procedure with the lowest UCB score among the operation procedures outputted by the first preference optimization large language model; the fifth operation procedure and the sixth operation procedure are both used to obtain a webpage address of a fourth query target on a fourth target website related to the second sample text; and the fourth query target is determined according to the second sample text; and obtaining the first large language model by performing at least one round of direct preference optimization on the first preference optimization large language model according to the second sample text and the second preference data pair.

As a possible implementation of the embodiments of the disclosure, the apparatus further includes: an address obtaining module configured to obtain a fifth webpage address through a seventh operation procedure corresponding to the second sample text, in which the seventh operation procedure is used for obtaining a webpage address of a fifth query target on a fifth target website related to the second sample text, and the fifth query target is determined according to the second sample text.

The UCB score of the fifth operation procedure is determined according to a matching result of a sixth webpage address obtained through the fifth operation procedure with the fifth webpage address and according to a probability that the first preference optimization large language model outputs the fifth operation procedure. The UCB score of the sixth operation procedure is determined according to a matching result of a seventh webpage address obtained through the sixth operation procedure with the fifth webpage address and according to a probability that the first preference optimization large language model outputs the sixth operation procedure.

As a possible implementation of the embodiments of the disclosure, the apparatus further includes: a third processing module configured to obtain an eighth operation procedure by inputting the first sample text into an initial large language model, in which the eighth operation procedure is used for obtaining a webpage address of a sixth query target on a sixth target website related to the first sample text, and the sixth query target is determined according to the first sample text; and obtain the fine-tuning large language model by performing a supervised fine-tuning training on the initial large language model according to the eighth operation procedure and the first operation procedure.

It should be noted that the above explanation of the embodiments of the method for training the large language model is also applicable to the apparatus for training the large language model of the embodiment, which will not be repeated here.

According to the apparatus for training the large language model in the embodiments of the disclosure, the second operation procedure of the first sample text is obtained by the first large language model, and the second webpage address obtained by the interaction performed based on the second operation procedure by the first large language model with the sample browser is obtained. After matching the first webpage address obtained by the first operation procedure based on the first sample text with the first webpage address, a matching result is obtained. According to the matching result, the target reward value is determined for the interaction between the first large language model and the sample browser. The reinforcement learning training is performed on the first large language model according to the target reward value to obtain the second large language model, which may analyze a text under a webpage navigation task and accurately determine an operation procedure for obtaining a query target in a target website related to the corresponding text, so as to facilitate the subsequent accurate acquisition of a webpage address of the query target meeting the user's needs based on the operation procedure.

In order to realize the above embodiments, the disclosure also provides an information interaction apparatus.

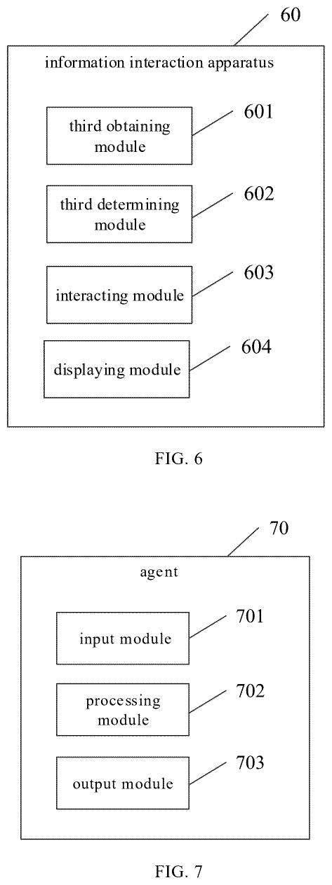

FIG. 6 is a schematic diagram according to a sixth embodiment of the disclosure.

As illustrated in FIG. 6, the information interaction apparatus 60 includes: a third obtaining module 601, a third determining module 602, an interacting module 603 and a displaying module 604.

The third obtaining module 601 is configured to obtain a text to be processed under a webpage navigation task.

The third determining module 602 is configured to determine a target operation procedure corresponding to the text to be processed according to a second large language model, in which the target operation procedure is used for obtaining a webpage address of a seventh query target on a seventh target website related to the text to be processed, the seventh query target is determined based on the text to be processed, and the second large language model is trained with the method for training the large language model according to the disclosure.

The interacting module 603 is configured to obtain a target webpage address of the seventh query target by interacting with the seventh target website on a preset browser based on the target operation procedure.

The displaying module 604 is configured to display a webpage corresponding to the target webpage address on the preset browser.

It should be noted that the above explanation of the embodiments of the information interaction method is also applicable to the information interaction apparatus of the embodiments, which will not be repeated here.

With the information interaction apparatus according to the embodiments of the disclosure, the text to be processed under the webpage navigation task is obtained, and the target operation procedure corresponding to the text to be processed is determined according to the second large language model. Based on the target operation procedure, the target webpage address of the seventh query target is obtained through interacting with the seventh target website on the preset browser, and the webpage corresponding to the target webpage address is displayed on the preset browser. Therefore, based on the text to be processed inputted by the user under the webpage navigation task, the webpage of the query target related to the text to be processed is automatically displayed on the preset browser.

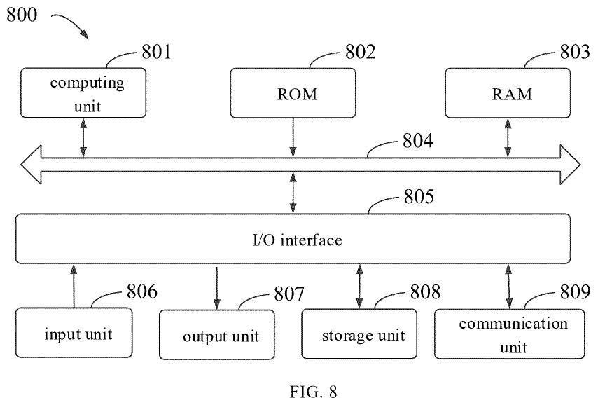

FIG. 7 is a schematic diagram of an agent 700 provided according to an embodiment of the disclosure.

As illustrated in FIG. 7, the agent 700 includes: an input module 701, a processing module 702 and an output module 703.

The input module 701 is configured to obtain a text to be processed under a webpage navigation task.

The processing module 702 is configured to determine a target operation procedure corresponding to the text to be processed according to a second large language model, in which the target operation procedure is used for obtaining a webpage address of a seventh query target on a seventh target website related to the text to be processed, and the seventh query target is determined based on the text to be processed; and obtain a target webpage address of the seventh query target by interacting with the seventh target website on a preset browser based on the target operation procedure, in which the second large language model is trained with the method for training the large language model according to the disclosure.

The output module 703 is configured to output the target webpage address.

With the agent according to the embodiments of the disclosure, the text to be processed under the webpage navigation task is obtained, and the target operation procedure corresponding to the text to be processed is determined according to the second language model. Based on the target operation procedure, the target webpage address of the seventh query target is obtained by interacting with the seventh target website on the preset browser, and the webpage corresponding to the target webpage address is displayed on the preset browser. Therefore, based on the text to be processed inputted by the user under the webpage navigation task, the webpage of the query target related to the text to be processed is automatically displayed on the preset browser.

In the technical solutions of the disclosure, the collection, storage, usage, processing, transmission, provision and disclosure of personal information of the user are all carried out with the consent of the user, and they all comply with the provisions of relevant laws and regulations, and do not violate public order and good customs.

According to the embodiments of the disclosure, the disclosure also provides an electronic device, a readable storage medium and a computer program product.

FIG. 8 is a block diagram of an electronic device 800 according to an embodiment of the disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile devices, such as personal digital processors, cellular phones, smart phones, wearable devices, and other similar computing devices. The components shown here, their connections and relations, and their functions are merely examples, and are not intended to limit the implementations of the disclosure described and/or required herein.

As illustrated in FIG. 8, the electronic device 800 includes: a computing unit 801 for performing various appropriate actions and processes according to computer programs stored in a read-only memory (ROM) 802 or computer programs loaded from a storage unit 808 to a random access memory (RAM) 803. The RAM 803 may also stores necessary programs and data for the electronic device 800 to operate. The computing unit 801, the ROM 802 and the RAM 803 are connected to each other through a bus 804. An input/output (I/O) interface 805 is also connected to the bus 804.

Components in the device 800 are connected to the I/O interface 805, including: an input unit 806, such as a keyboard and a mouse; an output unit 807, such as various types of displays and speakers; the storage unit 808, such as a disk and an optical disk; and a communication unit 809, such as a network card, a modem and a wireless communication transceiver. The communication unit 809 allows the electronic device 800 to exchange information/data with other devices through a computer network such as the Internet and/or various telecommunication networks.

The computing unit 801 may be various general-purpose and/or dedicated processing components having processing and computing capabilities. Some examples of the computing unit 801 include, but are not limited to, a central processing unit (CPU), a graphics processing unit (GPU), various dedicated artificial intelligence computing chips, various computing units that run machine learning model algorithms, a digital signal processor (DSP) and any appropriate processor, controller or microcontroller. The computing unit 801 executes the various methods and processes described above, such as the method for training the large language model and the information interaction method. For example, in some embodiments, the method for training the large language model or the information interaction method may be implemented as a computer software program, which is tangibly contained in a machine readable medium, such as the storage unit 808. In some embodiments, part or all of the computer programs may be loaded and/or installed on the electronic device 800 via the ROM 602 and/or the communication unit 809. When the computer program is loaded on the RAM 803 and executed by the computing unit 801, one or more steps of each of the above methods may be executed. Alternatively, in other embodiments, the computing unit 801 may be configured to perform the method for training the large language model or the information interaction method in any other suitable manner (for example, by means of firmware).

Various implementations of the systems and techniques described above may be implemented by a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware/firmware/software, and/or any combination thereof. These implementations may be implemented in one or more computer programs, the one or more computer programs may be executed and/or interpreted on a programmable system including at least one programmable processor, which may be a dedicated or general programmable processor for receiving data and instructions from a storage system, at least one input device and at least one output device, and transmitting data and instructions to the storage system, the at least one input device and the at least one output device.

The program code configured to implement the method of the disclosure may be written in any combination of one or more programming languages. These program codes may be provided to a processor/controller of a general-purpose computer, a dedicated computer or any other programmable data processing device, so that when the program code is executed by the processor/controller, the functions/operations specified in the flowchart and/or block diagram can be implemented. The program code may be executed entirely on the machine, partly executed on the machine, partly executed on the machine and partly executed on the remote machine as an independent software package, or entirely executed on the remote machine or the server.

In the context of the disclosure, a machine-readable medium may be a tangible medium that may contain or store a program for use by or in combination with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system/apparatus/device, or any suitable combination of the above. More specific examples of the machine-readable storage medium include electrical connections based on one or more wires, portable computer disks, hard disks, RAMs, ROMs, electrically programmable ROMs (EPROMs) or flash memories, fiber optics, compact disc ROMs (CD-ROMs), optical storage devices, magnetic storage devices, or any suitable combination of the foregoing.

In order to provide an interaction with a user, the systems and techniques described herein may be implemented on a computer having a display device (e.g., a cathode ray tube (CRT) or a liquid crystal display (LCD) monitor) for displaying information to the user; and a keyboard and a pointing device (such as a mouse or a trackball) through which the user can provide input to the computer. Other kinds of devices may also be used to provide the interaction with the user. For example, the feedback provided to the user may be any form of sensory feedback (e.g., visual feedback, auditory feedback or haptic feedback), and the input from the user may be received in any form (including acoustic input, voice input or tactile input).

The systems and technologies described herein can be implemented in a computing system that includes back-end components (for example, a data server), or a computing system that includes middleware components (for example, an application server), or a computing system that includes front-end components (for example, a user computer with a graphical user interface or a web browser, through which the user can interact with the implementations of the systems and technologies described herein), or a computing system that includes any combination of such back-end components, middleware components and front-end components. The components of the system may be interconnected by any form or medium of digital data communication (e.g., a communication network). The communication network may include, for example, a local area network (LAN), a wide area network (WAN), and the Internet.

The computer system may include a client and a server. The client and the server are generally remote from each other and interacting through a communication network. The client-server relation is generated by computer programs running on the respective computers and having a client-server relation with each other. The server may be a cloud server, a server with a distributed system, or a server combined with a block-chain.

It is understandable that the steps can be reordered, added or deleted using various forms of the processes shown above. For example, the steps in the disclosure may be performed in parallel, sequentially or in different orders, as long as the desired results of the technical solutions disclosed in the disclosure are achieved, which is not limited herein.

The specific implementations described above do not constitute a limitation on the scope of protection of the disclosure. It should be understood by those skilled in the art that various modifications, combinations, sub-combinations and substitutions can be made depending on the design requirements and other factors. Any modifications, equivalent substitutions and improvements made within the spirit and principles of the disclosure shall be included in the scope of protection of the disclosure.

What is claimed is:

1. A method for training a large language model, comprising:
obtaining a first sample text under a webpage navigation task, a first operation procedure corresponding to the first sample text, and a first webpage address obtained based on the first operation procedure, wherein the first operation procedure is used for obtaining a webpage address of a first query target on a first target website related to the first sample text, and the first query target is determined based on the first sample text;
determining a second operation procedure of the first sample text based on the first sample text and a first large language model, wherein the second operation procedure is used for obtaining a webpage address of a second query target on a second target website related to the first sample text, and the second query target is determined based on the first sample text;
obtaining a second webpage address obtained through an interaction performed based on the second operation procedure by the first large language model with a sample browser;
determining a target reward value for the interaction between the first large language model and the sample browser based on the first webpage address and the second webpage address; and
obtaining a second large language model by performing a reinforcement learning training on the first large language model based on the target reward value.

2. The method of claim 1, wherein obtaining the first sample text comprises:
obtaining a text template under the webpage navigation task and a prompt word template corresponding to the text template, wherein the text template comprises a position to be filled, and the prompt word template comprises a plurality of candidate contents to be filled in the position to be filled; and
selecting a target content from the plurality of candidate contents, and obtaining the first sample text by filling the target content in the position to be filled in the text template.

3. The method of claim 2, wherein selecting the target content from the plurality of candidate contents, and obtaining the first sample text by filling the target content in the position to be filled in the text template comprise:
generating a first prompt word based on the text template and the prompt word template, wherein the first prompt word is used for instructing a sample generating large model to select a target content from the plurality of candidate contents and obtain the first sample text by filling the target content in the position to be filled in the text template; and
inputting the first prompt word into the sample generating large model, and obtaining the first sample text outputted by the sample generating large model.

4. The method of claim 1, wherein in a case that there are a plurality of second operation procedures, and determining the target reward value for the interaction between the first large language model and the sample browser based on the first webpage address and the second webpage address comprises:
obtaining respective matching results by matching second webpage addresses corresponding to the second operation procedures with the first webpage address respectively; and
determining the target reward value for the interaction between the first large language model and the sample browser based on the respective matching results.

5. The method of claim 1, further comprising:
inputting the first sample text to a fine-tuning large language model, and obtaining a first preference data pair of the first sample text by sampling an output of the fine-tuning large language model, wherein the first preference data pair comprises a third operation procedure and a fourth operation procedure; the third operation procedure is an operation procedure with a highest upper confidence bound (UCB) score among operation procedures outputted by the fine-tuning large language model, and the fourth operation procedure is an operation procedure with a lowest UCB score among the operation procedures outputted by the fine-tuning large language model; the third operation procedure and the fourth operation procedure are both used to obtain a webpage address of a third query target on a third target website related to the first sample text; and the third query target is determined based on the first sample text; and
obtaining the first large language model by performing a direct preference optimization training on the fine-tuning large language model based on the first sample text and the first preference data pair.

6. The method of claim 5, wherein a UCB score of the third operation procedure is determined based on a matching result of a third webpage address obtained through the third operation procedure with the first webpage address and based on a probability that the fine-tuning large language model outputs the third operation procedure, and a UCB score of the fourth operation procedure is determined based on a matching result of a fourth webpage address obtained through the fourth operation procedure with the first webpage address and based on a probability that the fine-tuning large language model outputs the fourth operation procedure.

7. The method of claim 5, further comprising:
obtaining a second sample text under the webpage navigation task, wherein a difficulty level of the second sample text is greater than that of the first sample text;
wherein obtaining the first large language model by performing the direct preference optimization training on the fine-tuning large language model based on the first sample text and the first preference data pair comprises:
obtaining a first preference optimization large language model by performing at least one round of direct preference optimization training on the fine-tuning large language model based on the first sample text and the first preference data pair;
inputting the second sample text into the first preference optimization large language model, and obtaining a second preference data pair of the second sample text by sampling an output of the first preference optimization large language model, wherein the second preference data pair comprises a fifth operation procedure and a sixth operation procedure; the fifth operation procedure is an operation procedure with a highest UCB score among operation procedures outputted by the first preference optimization large language model, and the sixth operation procedure is an operation procedure with a lowest UCB score among the operation procedures outputted by the first preference optimization large language model; the fifth operation procedure and the sixth operation procedure are both used to obtain a webpage address of a fourth query target on a fourth target website related to the second sample text; and the fourth query target is determined based on the second sample text; and
obtaining the first large language model by performing at least one round of direct preference optimization on the first preference optimization large language model based on the second sample text and the second preference data pair.

8. The method of claim 7, further comprising:
obtaining a fifth webpage address through a seventh operation procedure corresponding to the second sample text, wherein the seventh operation procedure is used for obtaining a webpage address of a fifth query target on a fifth target website related to the second sample text, and the fifth query target is determined based on the second sample text;
wherein a UCB score of the fifth operation procedure is determined based on a matching result of a sixth webpage address obtained through the fifth operation procedure with the fifth webpage address and based on a probability that the first preference optimization large language model outputs the fifth operation procedure, and a UCB score of the sixth operation procedure is determined based on a matching result of a seventh webpage address obtained through the sixth operation procedure with the fifth webpage address and based on a probability that the first preference optimization large language model outputs the sixth operation procedure.

9. The method of claim 5, further comprising:
obtaining an eighth operation procedure by inputting the first sample text into an initial large language model, wherein the eighth operation procedure is used for obtaining a webpage address of a sixth query target on a sixth target website related to the first sample text, and the sixth query target is determined based on the first sample text; and
obtaining the fine-tuning large language model by performing a supervised fine-tuning training on the initial large language model based on the eighth operation procedure and the first operation procedure.

10. An information interaction method, comprising:
obtaining a text to be processed under a webpage navigation task;
determining a target operation procedure corresponding to the text to be processed based on a second large language model, wherein the target operation procedure is used for obtaining a webpage address of a seventh query target on a seventh target website related to the text to be processed, the seventh query target is determined based on the text to be processed, and the second large language model is trained according to the method of claim 1;
obtaining a target webpage address of the seventh query target by interacting with the seventh target website on a preset browser based on the target operation procedure; and
displaying a webpage corresponding to the target webpage address on the preset browser.

11. An electronic device, comprising:
at least one processor; and
a memory communicatively connected to the at least one processor;
wherein the at least one processor is configured to:
obtain a first sample text under a webpage navigation task, a first operation procedure corresponding to the first sample text, and a first webpage address obtained based on the first operation procedure, wherein the first operation procedure is used for obtaining a webpage address of a first query target on a first target website related to the first sample text, and the first query target is determined based on the first sample text;
determine a second operation procedure of the first sample text based on the first sample text and a first large language model, wherein the second operation procedure is used for obtaining a webpage address of a second query target on a second target website related to the first sample text, and the second query target is determined based on the first sample text;
obtain a second webpage address obtained through an interaction performed based on the second operation procedure by the first large language model with a sample browser;
determine a target reward value for the interaction between the first large language model and the sample browser based on the first webpage address and the second webpage address; and
obtain a second large language model by performing a reinforcement learning training on the first large language model based on the target reward value.

12. The electronic device of claim 11, wherein the at least one processor is configured to:
obtain a text template under the webpage navigation task and a prompt word template corresponding to the text template, wherein the text template comprises a position to be filled, and the prompt word template comprises a plurality of candidate contents to be filled in the position to be filled; and
select a target content from the plurality of candidate contents, and obtain the first sample text by filling the target content in the position to be filled in the text template.

13. The electronic device of claim 12, wherein the at least one processor is configured to:
generate a first prompt word based on the text template and the prompt word template, wherein the first prompt word is used for instructing a sample generating large model to select a target content from the plurality of candidate contents and obtain the first sample text by filling the target content in the position to be filled in the text template; and
input the first prompt word into the sample generating large model, and obtain the first sample text outputted by the sample generating large model.

14. The electronic device of claim 11, wherein in a case that there are a plurality of second operation procedures, and the at least one processor is configured to:
obtain respective matching results by matching second webpage addresses corresponding to the second operation procedures with the first webpage address respectively; and
determine the target reward value for the interaction between the first large language model and the sample browser based on the respective matching results.

15. The electronic device of claim 11, wherein the at least one processor is further configured to:
input the first sample text to a fine-tuning large language model, and obtain a first preference data pair of the first sample text by sampling an output of the fine-tuning large language model, wherein the first preference data pair comprises a third operation procedure and a fourth operation procedure; the third operation procedure is an operation procedure with a highest upper confidence bound (UCB) score among operation procedures outputted by the fine-tuning large language model, and the fourth operation procedure is an operation procedure with a lowest UCB score among the operation procedures outputted by the fine-tuning large language model; the third operation procedure and the fourth operation procedure are both used to obtain a webpage address of a third query target on a third target website related to the first sample text; and the third query target is determined based on the first sample text; and
obtain the first large language model by performing a direct preference optimization training on the fine-tuning large language model based on the first sample text and the first preference data pair.

16. The electronic device of claim 15, wherein a UCB score of the third operation procedure is determined based on a matching result of a third webpage address obtained through the third operation procedure with the first webpage address and based on a probability that the fine-tuning large language model outputs the third operation procedure, and a UCB score of the fourth operation procedure is determined based on a matching result of a fourth webpage address obtained through the fourth operation procedure with the first webpage address and based on a probability that the fine-tuning large language model outputs the fourth operation procedure.

17. The electronic device of claim 15, wherein the at least one processor is further configured to:
obtain a second sample text under the webpage navigation task, wherein a difficulty level of the second sample text is greater than that of the first sample text;
wherein the processor is configured to:
obtain a first preference optimization large language model by performing at least one round of direct preference optimization training on the fine-tuning large language model based on the first sample text and the first preference data pair;
input the second sample text into the first preference optimization large language model, and obtain a second preference data pair of the second sample text by sampling an output of the first preference optimization large language model, wherein the second preference data pair comprises a fifth operation procedure and a sixth operation procedure; the fifth operation procedure is an operation procedure with a highest UCB score among operation procedures outputted by the first preference optimization large language model, and the sixth operation procedure is an operation procedure with a lowest UCB score among the operation procedures outputted by the first preference optimization large language model; the fifth operation procedure and the sixth operation procedure are both used to obtain a webpage address of a fourth query target on a fourth target website related to the second sample text; and the fourth query target is determined based on the second sample text; and
obtain the first large language model by performing at least one round of direct preference optimization on the first preference optimization large language model based on the second sample text and the second preference data pair.

18. The electronic device of claim 17, wherein the at least one processor is configured to:
obtain a fifth webpage address through a seventh operation procedure corresponding to the second sample text, wherein the seventh operation procedure is used for obtaining a webpage address of a fifth query target on a fifth target website related to the second sample text, and the fifth query target is determined based on the second sample text;
wherein a UCB score of the fifth operation procedure is determined based on a matching result of a sixth webpage address obtained through the fifth operation procedure with the fifth webpage address and based on a probability that the first preference optimization large language model outputs the fifth operation procedure, and a UCB score of the sixth operation procedure is determined based on a matching result of a seventh webpage address obtained through the sixth operation procedure with the fifth webpage address and based on a probability that the first preference optimization large language model outputs the sixth operation procedure.

19. The electronic device of claim 15, wherein the at least one processor is further configured to:
obtain an eighth operation procedure by inputting the first sample text into an initial large language model, wherein the eighth operation procedure is used for obtaining a webpage address of a sixth query target on a sixth target website related to the first sample text, and the sixth query target is determined based on the first sample text; and
obtain the fine-tuning large language model by performing a supervised fine-tuning training on the initial large language model based on the eighth operation procedure and the first operation procedure.

20. A non-transitory computer-readable storage medium, wherein the medium stores computer instructions, and the computer instructions are used to cause a computer to implement the method of claim 1.
